(19) United States
(12) Patent Application Publication
(10) Pub. No.: US 2015/0046451 A1
(43) Pub. Date: Feb. 12, 2015

(54) INFORMATION PROCESSING SYSTEM, INFORMATION PROCESSING METHOD, AND PROGRAM

(71) Applicant: CANON KABUSHIKI KAISHA, Tokyo (JP)

(72) Inventor: Koji Yamada, Yokohama-shi (JP)

(21) Appl. No.: 14/453,300

(22) Filed: Aug. 6, 2014

(30) Foreign Application Priority Data
Aug. 9, 2013 (JP) 2013-166253

(51) Int. Cl. G06F 17/30

(52) U.S. Cl. CPC G06F 17/30595
USPC 707/736

(57) ABSTRACT

A system enabling use of an application program suitable for a user environment includes an obtaining unit that obtains first application program information associated with a first application program used with a first identifier, a determination unit that determines an application program suitable for a second identifier based on the first application program information obtained by the obtaining unit and a second application program information associated with each of application programs, and
an association unit that associates the application program determined by the determination unit with the second identifier.

### BACKGROUND

1. Field

Aspects of the present invention generally relate to information processing systems, information processing methods, and programs for performing processing by using an application program.

2. Description of the Related Art

Application software which is installed (copied) in a terminal for use has been known. In a case where a terminal is a personal computer (hereinafter, called a PC), for example, an application program may be distributed in a CD-ROM or over a network and be copied to a local storage (such as a hard disk) in a PC by using an installer program. A server system has been known in which package management software (such as rpm and dpkg) may be used to copy an application program in a CD-ROM or over a network to a local storage in a PC.

In such an environment, when a user replaces a PC, re-installation of an application program installed in a previous PC to the replaced PC may be required instead of copying it to the new PC. This is because some PCs have different versions of operating system and other different components, and file sets having been installed in one PC may not work in a different PC by only copying them to the different PC. However, re-installation of such a file set to a different PC may not allow inheriting previous settings, which may complicate construction of settings in the different PC.

Accordingly, Japanese Patent Laid-Open No. 2009-237930, for example, proposes that a software program on a terminal may be copied to a different terminal and may be operated by downloading a proper addition software program, without re-installing it to the different terminal.

By the way, application programs (Web application programs) which may be utilized without being installed in a local storage of a PC have increasingly spread with increases of network speeds and increases of speeds and functionality of Web browsers in recent years. Such an application program may be managed by registering a URL of the Web application program in bookmarks of a Web browser or linking to an account of a Web portal site. For example, a Web application program may have a unique URL which may be bookmarked for use. In a portal site which allows each user to customize, an application program may be utilized as a function within the portal site after a user logs in. Some Web browsers may have functionality for registering and managing a Web application program so that a Web application program thus may be registered and managed in linkage with a predetermined user account. With such a Web browser, a user may use a different PC from the one that the user normally uses to utilize a Web application program by logging in with a predetermined user account.

However, in some use environments, when a Web application program is utilized by logging in with a predetermined user account, the application program may not operate. Furthermore, in order to utilize one application program with different user IDs, the Web application program must be registered again individually in the same manner as in the previous PC.

### SUMMARY

Aspects of the present invention generally provide for enabling easy use of an application program suitable for a use environment.

According to an aspect of the present invention, a system includes

an obtaining unit configured to obtain first application program information associated with a first application program used with a first identifier, a determination unit configured to determine an application program suitable for a second identifier based on the first application program information obtained by the obtaining unit and a second application program information associated with each of application programs, and an association unit configured to associate the application program determined by the determination unit with the second identifier.

Further features of the present disclosure will become apparent from the following description of exemplary embodiments with reference to the attached drawings.

### BRIEF DESCRIPTION OF THE DRAWINGS

FIG. 1 is a schematic view of an information processing system according to a first embodiment.

FIG. 2 illustrates a hardware configuration of a server according to the first embodiment.

FIG. 3 illustrates a hardware configuration of a printer according to the first embodiment.

FIG. 4 illustrates a hardware configuration of a personal computer according to the first embodiment.

FIG. 5 illustrates a printer registration sequence according to the first embodiment.

FIG. 6 illustrates an example of a printer screen according to the first embodiment.

FIGS. 7A and 7B illustrate examples of a printing result and a new-user registration screen according to the first embodiment.

FIG. 8 illustrates an application program registration sequence according to the first embodiment.

FIGS. 9A and 9B illustrate examples of application program registration screens according to the first embodiment.

FIG. 10 illustrates a printer addition/registration sequence according to the first embodiment.

FIG. 11 illustrates an example of a printer addition/registration screen according to the first embodiment.

FIG. 12 is a flowchart illustrating application program copy processing according to the first embodiment.

FIGS. 13A and 13B exemplarily illustrate application program information according to the first embodiment.

### DESCRIPTION OF THE EMBODIMENTS

Exemplary embodiments will be described in detail with reference to the accompanying drawings. It should be noted that the following embodiments are not intended to limit the claimed invention, and all of combinations of characteristics according to the following embodiments are not always required for addressing issues according to the present disclosure.

### First Embodiment

A first exemplary embodiment will be described in detail below with reference to drawings. An information processing system according to this embodiment includes a printer to be utilized through an application program, a server which operates an application program, and a personal computer (PC) to be operated by a user.

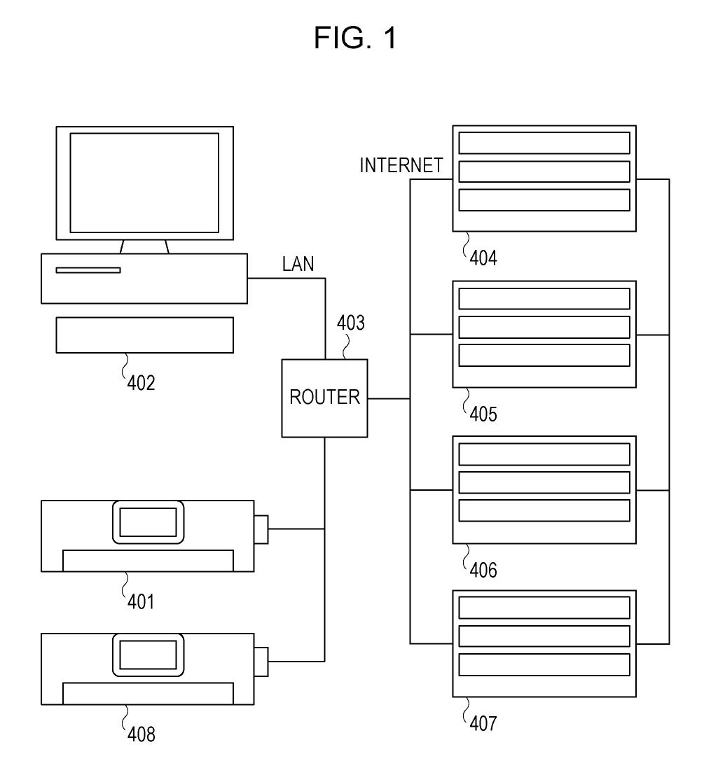

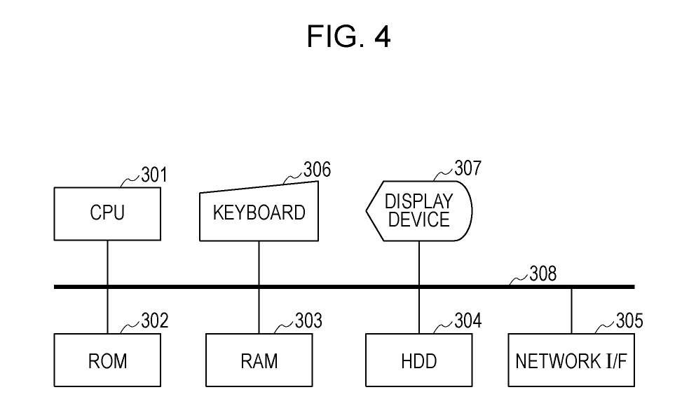

FIG. 1 is a schematic view illustrating an information processing system according to this embodiment. As illustrated in FIG. 4, the information processing system according to this embodiment includes a PC 402, two printers (printer 401, printer 408) and a server.

The printer 401 and printer 408 are connected to a network and have Web browsers.

The PC 402 is a PC connected to the network and is capable of managing and operating a Web application program registered with the printer 401.

A router 403 is usable for routing a communication within a LAN to the Internet.

The configurations of the printers, server, and PC included in the information processing system according to this embodiment will be described below.

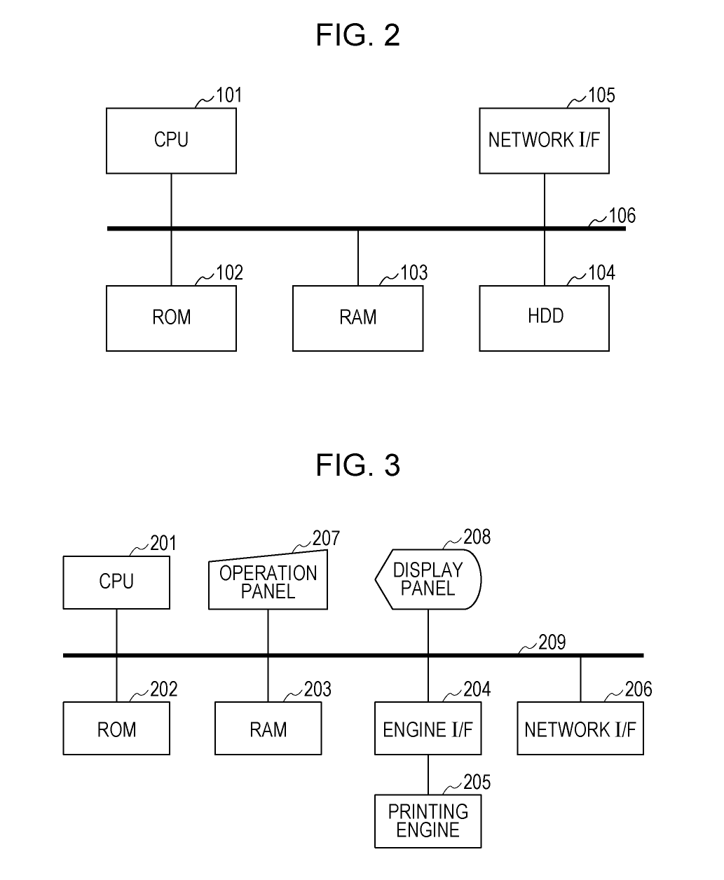

FIG. 2 illustrates a hardware configuration of the server according to this embodiment. As illustrated in FIG. 2, the server includes a central processing unit (CPU) 101, a ROM 102, a RAM 103, an HDD 104, and a network interface 105, which are connected via a bus 106.

The CPU 101 executes a program in the ROM 102 or RAM 103. The ROM 102 holds an activating program. The activating program is utilized for activation only. After the server is activated, an operating system in the RAM 103 is executed. In the RAM 103, the operating system is executed, and application programs including a server program may be executed on the operating system.

The HDD 104 may be an external storage and holds an operating system and application programs in file formats.

The network interface (IF) 105 is usable for communication with a client device.

The server according to this embodiment includes the components connected via the bus 106 for communication.

FIG. 3 illustrates a hardware configuration of each of the printers according to this embodiment. The printer illustrated in FIG. 3 has basically the same computer control configuration as the one illustrated in FIG. 2.

The printer includes a CPU 201, a ROM 202, a RAM 203, an engine interface (IF) 204, a network interface (IF) 206, an operation panel 207, and a display panel 208, which are connected via a bus 209. The printer further includes a printing engine 205.

The CPU 101 executes a program in the ROM 202 or RAM 203. If the printer does not have an external storage, information on an operating system and an application program is stored in the ROM 202. Though the printer does not have an external storage here, it may have an external storage. In this case, information on an application program may be stored in the external storage.

An operating system or an application program may be executed in the ROM 202 or may be copied to and then executed in the RAM 203.

The printing engine 205 may support an ink jet system or a laser beam printer system, for example.

The network IF 206 is usable for communication with an external device over a network.

The operation panel 207 receives a user's input operation. According to this embodiment, the operation panel 207 is provided as an input device configured to receive a user's input operation, but without limiting the foregoing, such an input device may be a touch panel integrated with a button provided on a printer and a display device.

The display panel 208 presents a predetermined processing result and a user interface (UI), for example, to a user. The display panel 208 may include, for example, a full-color liquid crystal and a few LEDs.

The CPU 201 may control the printing engine 205 through the engine interface 204 via the bus 209 such that each of the printers according to this embodiment may execute a printing process.

In each of the printers, a Web application program may be added, deleted, executed, and sorted through a Web browser.

FIG. 4 is a block diagram of a PC according to this embodiment.

As illustrated in FIG. 4, the PC includes a central processing unit (CPU) 301, a ROM 302, a RAM 303, an HDD 304, a network IF 305, a keyboard 306, and a display device 307, which are connected via a bus 308. The PC illustrated in FIG. 4 includes a keyboard for inputting and a display device, unlike the server in FIG. 2.

The CPU 301 executes a process based on a program. The ROM 302 stores a program to be executed by the CPU 301. The RAM 303 provides memory for temporarily storing information usable for execution of a program performed by the CPU 301. The HDD 304 is a storage medium usable for storing a file and a result of an information process.

The keyboard 306 is an input device usable by a user for operating the PC. Though the keyboard 306 is provided as an input device according to the present embodiment, any input device enabling practice of the present exemplary embodiment is applicable.

The display device 307 may be a display, for example, and may present a user a result of an information process and a user interface (UI), for example. The display device 307 may include a touch panel function.

The PC according to this embodiment may manage application programs for a printer owned by a user. The application programs here may include a Web application program, which will be described below. In the PC, Web application programs may be added, deleted, executed, and sorted through a Web browser.

When a printer is added to a printer owned by a user or when a printer owned by a user is replaced, the PC manages a Web application program associated with the printer managed previously by associating the web application program with the added or replaced printer. In this case, for management, each Web application program is associated by directly copying to the added or replaced printer or an application program suitable for a characteristic of the added or replaced printer is associated with, the details of which will be omitted. In the PC, an application program associated with the added or replaced printer may be added, deleted, executed, and sorted.

A PC has been provided as an example of an apparatus that manages application programs. However, using a PC as the apparatus is not seen to be limiting, and other devices, such as a smart phone, a tablet, etc. can be used.

Referring back to FIG. 1, the server according to this embodiment includes four of an app management server 404, an app server 405, a print server 406, and a mail server 407. Their internal hardware configurations are the same (see FIG. 2), but different server programs are to be executed therefor to cause them to play different roles.

The app management server 404 is a server configured to manage a Web application program. The term “Web application program” here refers to an application program to be used over a network and may operate as a result of cooperation between a program running on a Web browser and a program running in the Web server, for example. The Web application program is created in a format that is interpretable by a general Web browser, such as an HTML format. Information that the Web application program is registered with the printer is registered with the app management server 404. The PC 402 may access the app management server 404 to allow registration/deletion of a Web application program.

The app server 405 may provide a file in response to an instruction from a Web browser installed in the corresponding printer and execute a process or execute a Web application program.

The print server 406 may receive a print process from the app server 405, convert it to a print command, and notifies it to a predetermined printer (printer 401 here) after the conversion. The printer 401 may obtain a print command from the print server 406 to execute a printing process.

The mail server 407 may be used to send a mail to a user for user registration, the details of which will be described below.

Next, a sequence for linking the printer 401 and a user for registration, a Web application program registration sequence, and a printer addition/registration sequence will be described by using those servers (app management server 404, app server 405, print server 406, and mail server 407).

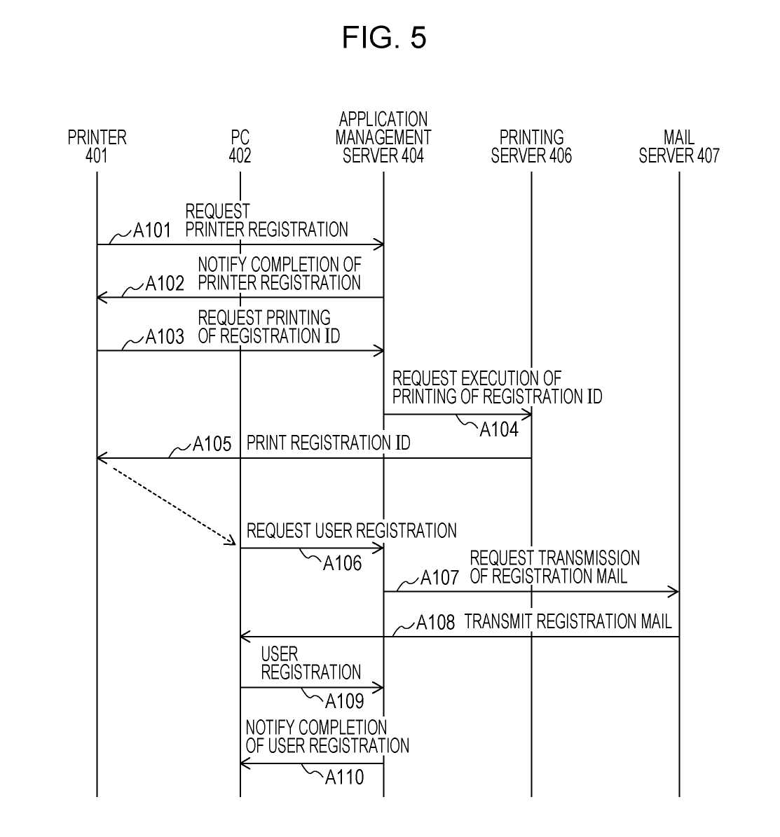

FIG. 5 illustrates a sequence for linking a printer and a user for registration. The sequence is performed for the purpose of linking a printer owned by a user and a user account. In the sequence illustrated in FIG. 5, the horizontal axis indicates hardware components illustrated in FIG. 1, and the vertical axis indicates a lapse of time for processing. The sequence starts in response to a user operation.

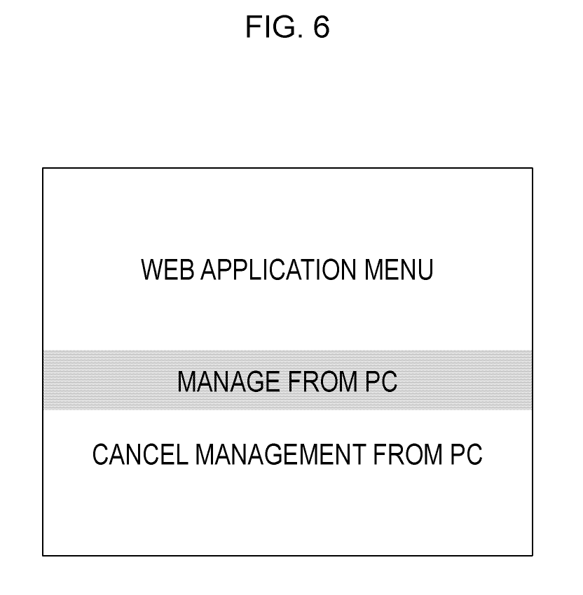

FIG. 6 illustrates a printer screen showing a user operation according to this embodiment. The printer screen illustrated in FIG. 6 is displayed by a Web browser on the display panel 208 of the printer 401. According to this embodiment, “MANAGE FROM PC” and “CANCEL MANAGEMENT FROM PC” are displayed under a Web application program menu. If a user selects “MANAGE FROM PC” in FIG. 6 from the display panel 208 of the printer 401, the sequence for linking the printer and the user for registration illustrated in FIG. 5 starts.

If the sequence starts, the printer 401 first requests a printer registration to the app management server 404 (A101). The app management server 404 in this step recognizes and manages the printer 401 connected to the Internet.

If the app management server 404 receives printer registration request from the printer 401, the app management server 404 generates and stores an identifier for managing a printer associated with a printer unique ID. If the printer registration completes, the app management server 404 sends a notification of completion of the printer registration to the printer 401 (A102). The notification of completion of the printer registration returns to the printer 401 the state that the app management server 404 is enabled to recognize and manage the printer 401.

In response to the notification of completion of the printer registration from the app management server 404, the printer 401 requests the app management server 404 to print the registration ID (A103).

The app management server 404 generates and stores the registration ID associated with the printer identifier in response to the request and generates print data containing the registration ID. The app management server 404 then requests execution of printing of the registration ID to the print server 406 (A104). In other words, the request for execution of printing is requested from the app management server 404 to the printer identifier to print the print data.

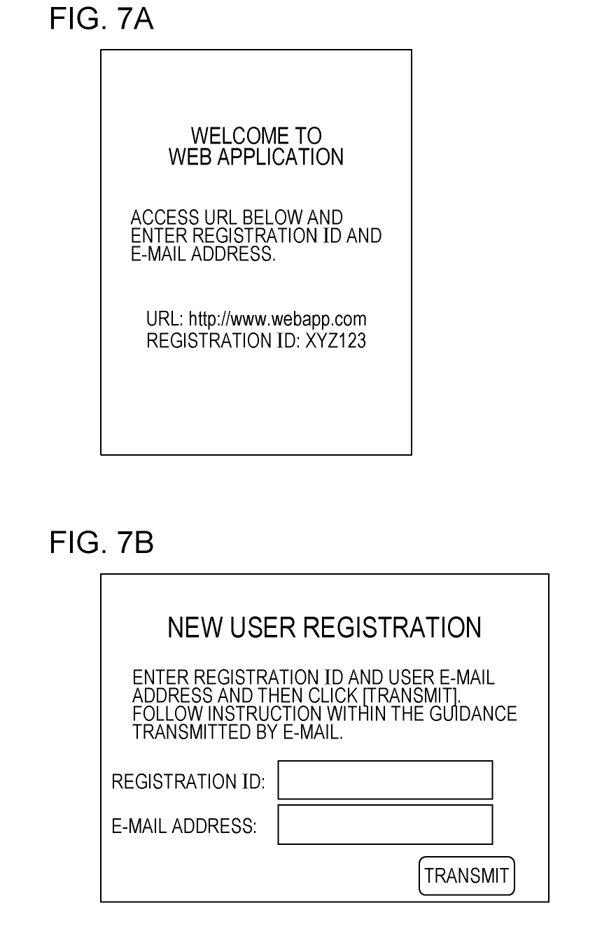

If the print server 406 receives the request for execution of printing the registration ID, the print server 406 requests the printer 401 to print the registration ID (A105). Thus, the registration ID is printed by the printer 401 owned by the user. FIG. 7A illustrates a result of the printing of a registration ID according to this embodiment. FIG. 7A illustrates an example in which a user is prompted to access a URL and enter a registration ID and an Email address.

If a user accesses the URL printed in A105 by using a Web browser installed in the PC 402 and performs user registration, a user registration request is executed based on the registration ID printed in A105 from the PC 402 to the app management server 404 (A106). FIG. 7B illustrates a Webpage for user registration. The Webpage for user registration illustrated in FIG. 7B is displayed by a Web browser on the display device 307 of the PC 402. The Webpage for user registration is displayed to prompt to enter information necessary for new user registration. In the example in FIG. 7B, a user is prompted to enter a registration ID and an Email address for user registration. If a registration ID and an Email address are entered on the Webpage in FIG. 7B and a “TRANSMIT” button is pressed, the user registration request is executed. According to this embodiment, the user ID may be an Email address of a user entered for user registration, for example.

In response to the user registration request, the app management server 404 requests the mail server 407 to transmit a registration mail (A107).

In response to the registration-mail transmission request, the mail server 407 transmits a registration mail to the PC 402 (A108). The registration mail is transmitted by E mail and contains a URL for completion of the registration. The destination Email address of the registration mail corresponds to the one received in A106.

If a user clicks the URL contained in the registration mail, a screen prompting to enter a log-in password is displayed. If a user enters and transmits a log-in password, the user registration is requested from the PC 402 to the app management server 404 (A109). The app management server 404 generates a user identifier and saves the generated user identifier, user's Email address and printer identifier in association to complete the user registration.

The acceptance/refusal of the user registration is returned from the app management server 404 to the PC 402 (A110). When the registration completes, the completion of the user registration is notified from the app management server 404 to the PC 402.

Thus, the printer owned by the user may be registered with the server (app management server 404). According to this embodiment, uniqueness and existence may be secured through the use of a user ID and an Email address. However, the user ID is not limited to the foregoing. The user ID may be an ID automatically generated by a system or may be entered by a user, for example.

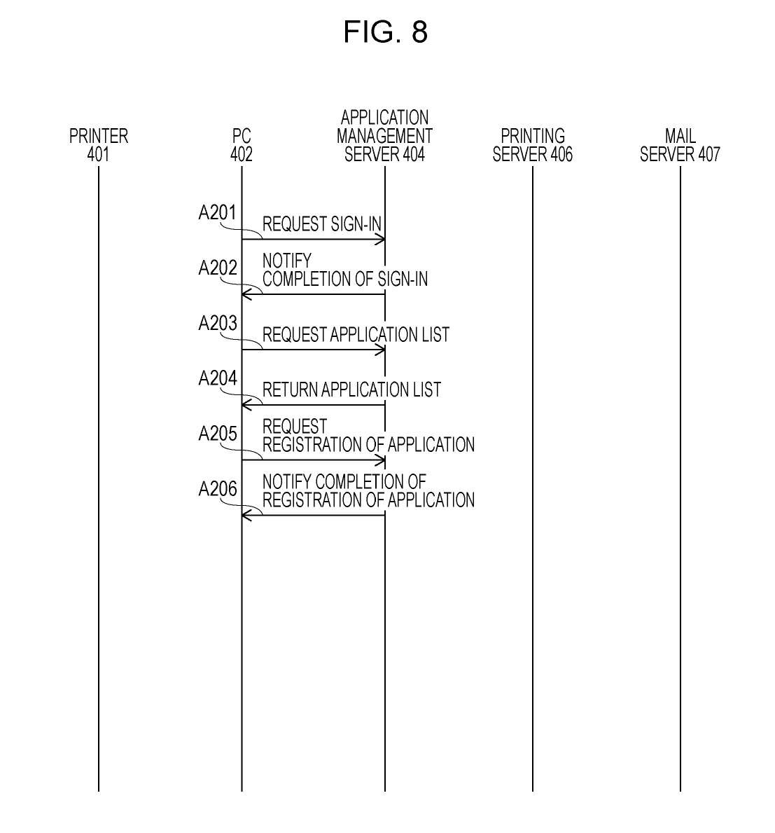

Next, Web application program registration sequence will be described with reference to FIG. 8. The sequence is performed for the purpose of registering a Web application program available for a printer.

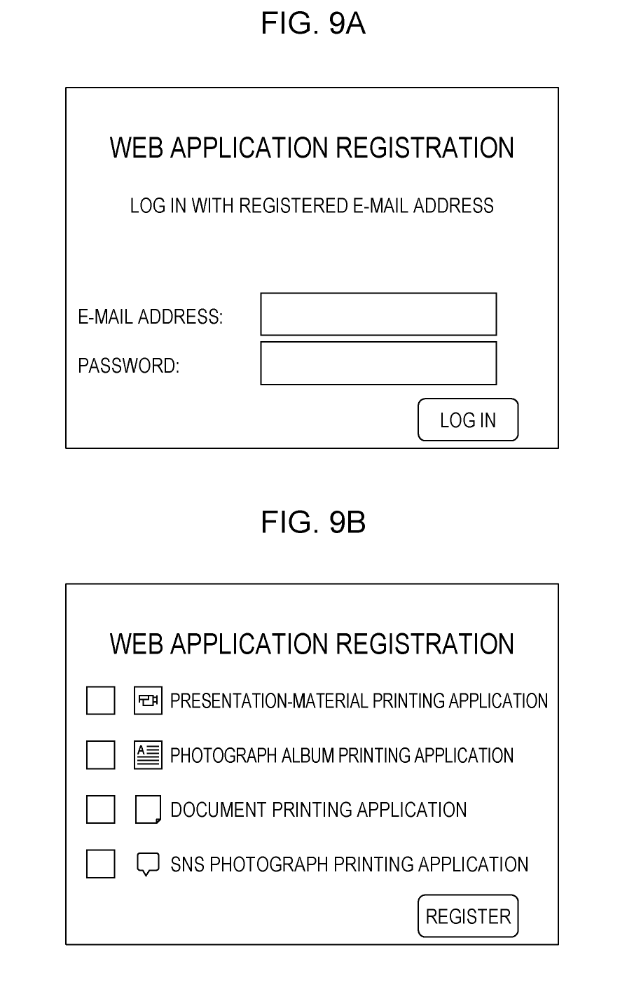

If a predetermined login URL is accessed from a Web browser installed in the PC 402, a login is requested from the PC 402 to the app management server 404 (A 201). FIG. 9A illustrates an example of a login screen of a Web browser displayed on the display device 307 in the PC 402. The login screen of the Web browser illustrated in FIG. 9A prompts a user to enter an Email address and a password for registration of a Web application program. If an Email address and a password are entered and a LOG IN button is pressed on the login screen, the PC 402 transmits the Email address and password entered by the user to the app management server 404.

The app management server 404 then searches a user identifier associated with the Email address transmitted from the PC 402 in A201, checks whether it is matched with the password. If so, the app management server 404 then searches a printer identifier. If a printer identifier is found by the search, the completion of the login operation is notified to the PC 402 (A202). According to the present embodiment, a password set based on a user's input is stored as a user identifier. In The use of this type of password is not seen to be limiting, and other passwords, such as an original password, may be used through a conversion of a user identifier using some hash.

In response to the notification of completion of the login operation, the PC 402 requests the app management server 404 a list of Web application programs (A203). A Web application program may have an app identifier, the details of which will be described below, and is managed based on the identifier.

In response to the app list request, the app management server 404 returns to the PC 402 a list of app identifiers, app name, and app icons of Web application programs stored within the app management server 404 (A204). The PC 402 displays on the display device 307 an app-to-be-registered selection screen based on the obtained app names and app icons. FIG. 9B illustrates the app-to-be-registered selection screen to be displayed on the display device 307 of the PC 402. The app-to-be-registered selection screen allows a user to select a Web application program to be registered from various Web application programs. The selection screen illustrated in FIG. 9B has check boxes for selecting a Web application program to be registered.

On the app-to-be-registered selection screen in FIG. 9B, a user may select a Web application program to be registered and press a REGISTER button. In response to this, the PC 402 transmits the identifier of the Web application program selected by the user and the printer identifier to the app management server 404 and requests app registration (A205).

The app management server 404 adds and registers the app identifier to and with Web application program list information managed with printer identifiers based on the app registration request from the PC 402. The app management server 404 then notifies the PC 402 of the completion of the app registration (A206).

The execution of the sequence for registering a Web application program allows a user to register a Web application program in association with a printer.

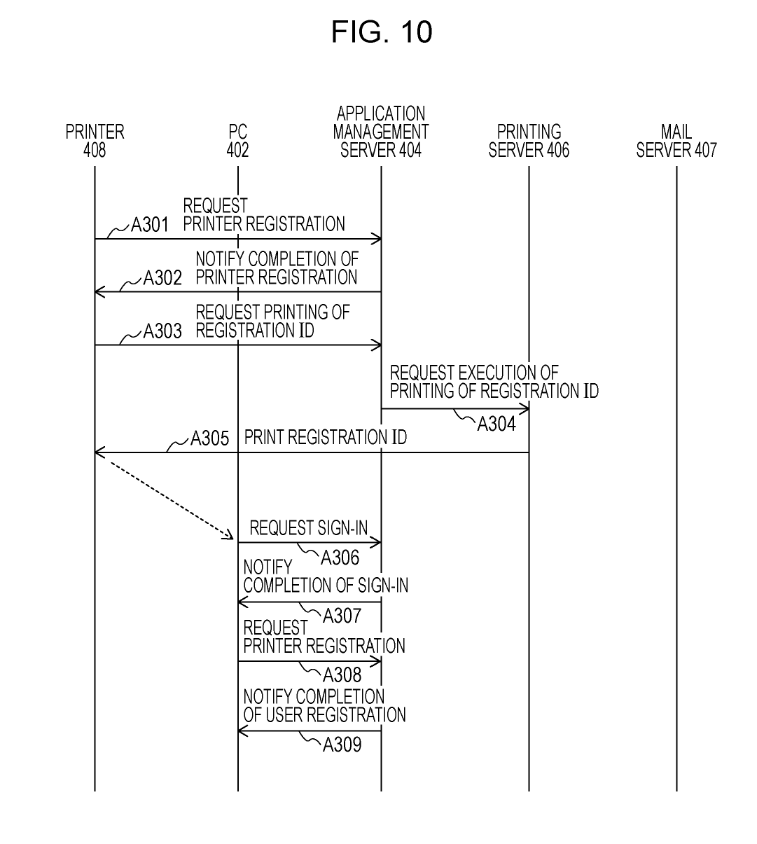

FIG. 10 is a printer addition/registration sequence. The printer addition/registration sequence is executed for the purpose of addition/registration of a printer to be performed when the printer is added or replaced after user registration. An example in which the printer 408 is additionally provided to the printer 401 as illustrated in FIG. 1 according to this embodiment will be described. The first five steps (printer registration request A301, printer registration completion notification A302, registration ID printing request A303, registration ID printing execution request A304, and registration ID print A305) are the same as the steps (A101 to A105) for the user registration described above.

First, the printer 408 requests a printer registration to the app management server 404 (A301). The app management server 404 in this step recognizes and manages the printer 408 connected to the Internet. In this case, the app management server 404 generates and stores an identifier for printer management associated with a printer unique ID.

After the app management server 404 stores the identifier for management and completes the printer registration, the app management server 404 returns to the printer 408 a notification that the app management server 404 is now enabled to recognize and manage the printer 408 (A302).

In response to the notification of completion of the printer registration, the printer 408 requests the app management server 404 to print the registration ID (A303).

The app management server 404 generates and stores a registration ID associated with the printer identifier in response to the registration ID print request from the printer 408 and requests execution of the registration ID printing to the print server 406 (A304). In other words, the request for execution of printing is requested by the app management server 404 to the printer with the printer identifier to print the print data including the registration ID.

In response to the request for execution of printing of the registration ID from the app management server 404, the print server 406 generates print data including the registration ID and requests the printer 408 to print the registration ID (A305). Thus, the registration ID is printed from the newly added printer 408 owned by the user. The result of the printing of the registration ID may be similar to the one illustrated in FIG. 7A, for example.

When a user accesses the URL and instructs a new user registration, the PC 402 requests processing for logging in to the app management server 404 (A306). More specifically, when a user enters a registered Email address and password on a login screen and presses a LOG IN button, the Email address and the password are transmitted to the app management server 404. Because the login screen is similar to the one illustrated in FIG. 9A, the description will be omitted.

In response to the login request, the app management server 404 returns whether the login processing has completed or not based on determination whether the entered Email address and password are matched with the registered information or not. If the Email address and password are matched with the registered information, the processing for logging in is completed. The app management server 404 then notifies the PC 402 of the completion of the processing for logging in.

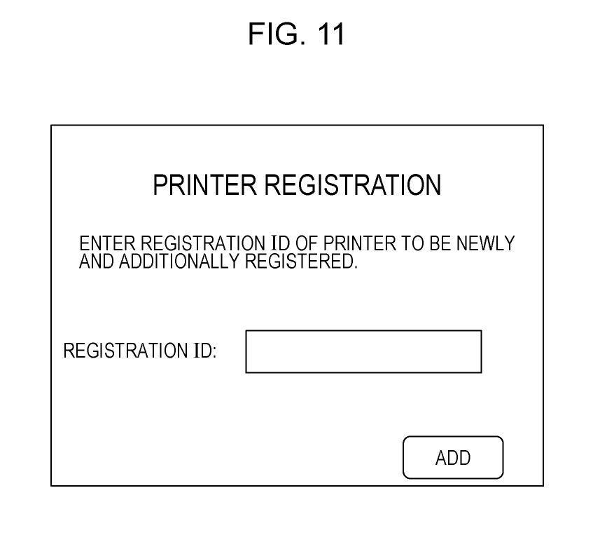

When the PC 402 successfully logs in (or is notified of the completion of the processing for logging in) and a user instructs a process for printer addition/registration, a printer registration screen as illustrated in FIG. 11 is displayed by the Web browser on the display device 307. According to this embodiment, the printer registration screen prompts to enter a registration ID of a printer to be newly added/registered. Referring to FIG. 11, when a user enters a registration ID of a printer to be newly added/registered and presses an ADD button, the registration ID is transmitted to the app management server 404. In other words, the PC 402 requests the app management server 404 to register the printer (A308).

The app management server 404 determines whether the registration ID received in response to the printer registration request is valid or not and, if so, performs registration processing therefor and notifies the completion of the printer registration to the PC 402 (A309).

Thus, the user may register the printer with the server and register a Web application program in association with the printer.

As described above, the Web application program is stored in a form of app identifier in the app management server 404 based on the printer identifier. In order to perform the registration processing, it is copied to a different printer identifier (app copy process). The app copy process may include not only a process for copying an app directly but also a process for changing it to an app suitable for a use environment and registering it. The use environment according to this embodiment is a type of device.

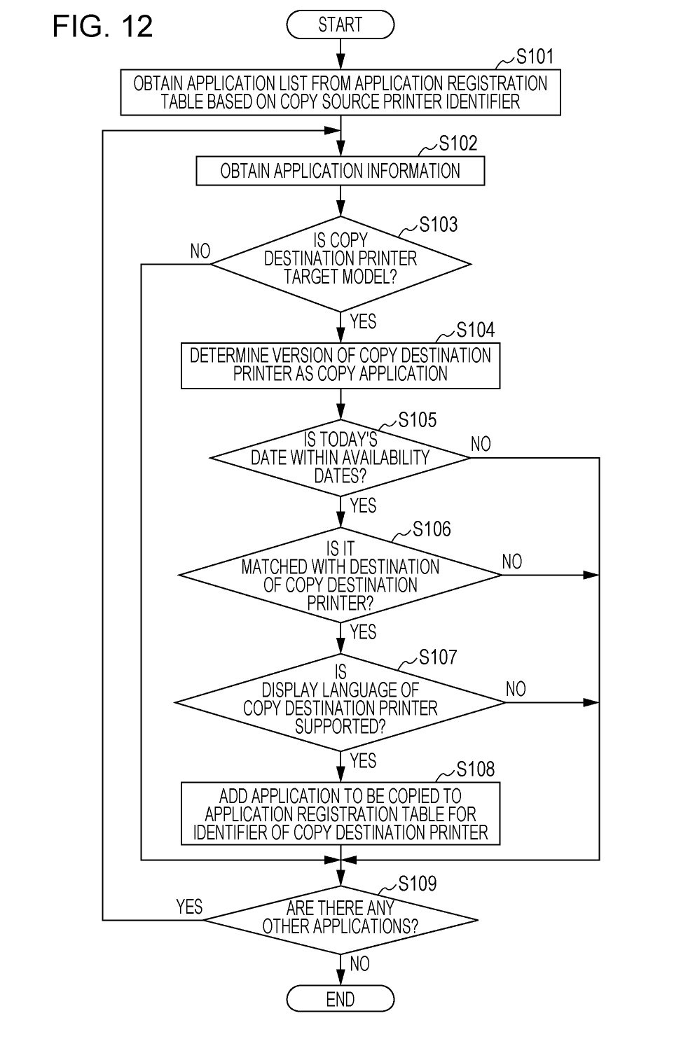

The app copy process will be described below with reference to a flowchart illustrated in FIG. 12. After the processing in A301 in FIG. 10 is performed, the app copy process illustrated in FIG. 12 is started. FIG. 12 illustrates a flowchart of the app copy process to be performed by executing a program stored in the HDD 104 by the CPU 101 in the app management server 404.

Once the app copy process starts, an application program list is first obtained from an app registration table based on copy source printer identifier (S101). Because the app management server 404 stores an app identifier in association with a printer identifier, information on the corresponding app identifier is obtained based on the printer identifier.

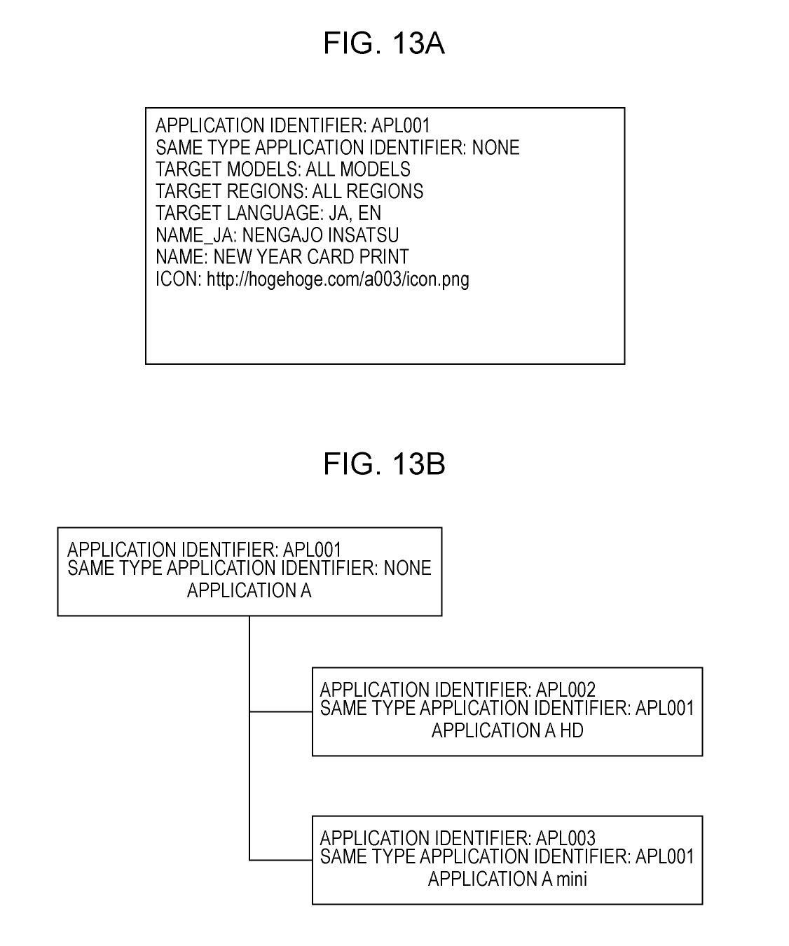

Next, application program information is obtained based on individual app identifiers (S102). FIGS. 13A and 13B illustrate examples of the application program information. According to this embodiment, as illustrated in FIG. 13A, information pieces on a same type app identifier, a target model, a target region, target language, Japanese name, English name and an icon are held as the application program information in association with an app identifier. The application program information is not limited thereto, but other or a part of information pieces may be held.

The same type app identifier in the application program information refers to information by which an application program type is identifiable and represents a derivative of a same type of application program. A relationship between an application program and a derivative will be described with reference to FIG. 13B. FIG. 13B illustrates a relationship satisfied in a case where app A HD of app identifier APL 002 and app A mini of app identifier APL 003 are derived from app A of app identifier APL 001. In this case, because app A is a parent of app A HD and app A mini, no same type app identifier is set for APL 001, resulting in “NONE”. On the other hand, APL 002 and APL 003 both have “APL 001” as the same type app identifier. From the same type app identifier, APL 001, APL 002, and APL 003 are recognized as the same type application programs, more specifically, an application program and its derivatives. In other words, the type of application program is identified based on the same type app identifiers.

The app with app identifier APL 001 illustrated in FIG. 13A does not have a same type app identifier but has “ALL MODELS” as a target model, “ALL REGIONS” as a target region, and Japanese and English as target languages. The Japanese name of the app is “NENGAJO INSATSU”, and the English name of the app is “NEW YEAR CARD PRINT”. The URL of an icon is also held in association with the app.

Referring back to the flowchart, after the application program information is obtained, whether an application program to be copied supports the destination printer as a target model is checked (S103). If not, the application program to be copied is not added to an app registration table of the copy destination printer identifier. Then, the flow proceeds to S109. On the other hand, if so, the flow proceeds to S104 where a version of the copy destination printer is determined as an application program to be copied. In other words, the application program with the app identifier indicating that the application program is operable in the copy destination printer determined in S103 is determined as an application program to be copied. After that, the flow proceeds to S105.

The determination on whether an application program requested to be copied supports a copy destination printer as a target model will be described below. Whether an application program requested to be copied supports a copy destination printer as a target model may be determined by checking the target model of the application program requested to be copied itself or a same type application program (derivative) of the application program requested to be copied. In other words, according to this embodiment, it may be checked whether the target models in the application program information of the app identifier registered with the copy source printer contain the copy destination printer and whether the target models in the application program information having the app identifier registered with the copy source printer as a same type app identifier contain the copy destination printer. Thus, a version suitable for the copy destination printer (application program having an app identifier registered with the copy source printer or an application program having an app identifier registered with the copy source printer as a same type app identifier) is determined as the application program to be copied. In a case where the copy destination printer is supported as a target model by the copy source application program and its derivative, the latest application program may be determined as a version suitable for the copy destination printer.

In S105, whether today's date is within a range of availability dates of the application program to be copied is determined. If so, the flow proceeds to S106. If not, the flow proceeds to S109.

In S106, whether the copy destination printer is matched with the destination of the application program to be copied is determined. If so, the flow moves to S107. If not, the flow moves to S109.

In S107, whether the language supported by the application program to be copied is matched with display language of the copy destination printer is determined. If so, the flow moves to S108. If not, the flow moves to S109.

In S108, an app identifier of the application program to be copied is added to an app registration table for an identifier of the copy destination printer. Then, the flow moves to S109.

In S110, whether any other application programs exist or, according to this embodiment, whether any other application program information exist is determined. If any other registered application programs exists, the flow returns to S102. If not, the flow ends.

As described above, the copy process is performed on each application program, and the same application programs as those in the copy source printer are copied (or associated) to (with) a copy destination printer or a different version of the application program from the one in the copy source printer is associated with a copy destination printer. An application program that is supported by a copy source printer but is not supported by a copy destination printer is not associated with the copy destination printer.

Through the flow described above, a printer added to the app management server 404 and an application program are registered in association with each other, and a result of the registration is notified to the PC. Thus, an added printer and an application program supported by the added printer are managed in association with each other in the PC.

According to this embodiment, the application program copy processing from the printer 401 to the different printer 408 may include changing an application program registered with the copy source printer to an application program suitable for the copy destination printer for registration with the app management server 404. In other words, in order to copy an application program from a first information processing apparatus to a second information processing apparatus, an application program suitable for the second application program is automatically associated for registration with the app management server 404. This may eliminate the necessity for selecting an application program more suitable for a user operation and allows automatic association and registration of a Web application program suitable for each printer. Thus, troubles in operations of an application program in a newly added printer may be prevented.

In other words, according to this embodiment, an application program suitable for a use environment may be easily associated. Thus, a user may correctly and easily use the application program.

### Other Embodiments

The above-described exemplary embodiments are not seen to be limiting. For example, while the first embodiment includes determining whether today's date is within a range of availability dates of an application program to be copied (S105), whether the copy destination printer is matched with the destination of the application program to be copied (S106), and whether the language supported by the application program to be copied is matched with display language (S107) and adding the application program to be copied if all of them are satisfied, this approach is not limiting. The conditions required for adding an application program to be copied are not limited those described above and may include other conditions, any one condition may be excluded, or may comprise other conditions. The order of those determinations is not limited to the one described above.

According to the above-described embodiment(s), a suitable application program is associated depending on the type of printer. A suitable application program may be associated depending on a use environment of the application program. The use environment for an application program may be a model of a device in which the application program is to be used, a region where the application program is to be used, language selected by a user for use of the application program, or the like. In other words, whether the use environment as described above for an application program to be copied is supported or not may be a criterion for determination of a suitable application program for an identifier of a candidate printer for association between them.

According to the above-described embodiment(s), an app identifier is used as identification information for an application program, for example, it is not limited thereto as far as identification of an application program is allowed.

According to the above-described embodiment(s), the server has four apparatuses of the app management server 404, app server 405, print server 406, and mail server 407. The use of four separate apparatuses is not seen to be limiting, and one or all of them may be integrated into a single apparatus.

According to the above-identified embodiment(s), a printer is used as an example of a candidate device. The use of a printer is not seen to be limiting. For example, in another embodiment, a copy machine, a facsimile, a cellular phone, a PDA, an image viewer, a digital camera, etc. can be used.

Though a device unique ID (printer unique ID) has been described as a registration ID according to the above-described embodiment(s), the registration ID is not limited to being a device unique ID. For example, a user unique ID or a group unique ID for a group of a plurality of users is applicable. In other words, an application program such as a Web application program may be associated with each user or each group of users. In this case, for example, an application program that supports a device owned by a user may be associated with a user unique ID, or an application program supported by a device owned by a user included in a group may be associated with its group unique ID. When a user uses a PC different from a PC that he/she normally uses, he\she may utilize a same Web application program by logging in with a predetermined user account. Not only an application program supported nu a device owned by a user or a device owned by a group of users may be associated with a user unique ID or a group unique ID, but also all derivatives of the application program may be associated therewith. This may prevent inoperability of an application program in different use environments or, for example, in a device that is different from a user normally uses.

The above-described embodiment(s) may be implemented by execution of the following processing. That is, software (program) for implementing the functionality of the embodiment(s) may be supplied to a system or an apparatus over a network or in a storage medium, and a computer (such as a CPU or an MPU) in the system or apparatus may read out and execute the program. Such a program may be executed in one computer or may be executed by a plurality of computers that operate together. All of processes described above are not required to be implemented by software, but a part or all of the processes may be implemented by hardware such as an ASIC. One CPU may not be required to execute all of the processes, but a plurality of CPUs may properly operate together to execute the processes.

Additional embodiment(s) can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-166253 filed Aug. 9, 2013, which is hereby incorporated by reference herein in its entirety.

What is claimed is:

1. A system comprising:
an obtaining unit configured to obtain first application program information associated with a first application program used with a first identifier;
a determination unit configured to determine an application program suitable for a second identifier based on the first application program information and a second application program information associated with each of application programs; and
an association unit configured to associate the application program determined by the determination unit with the second identifier.

2. The system according to claim 1, wherein if it is determined by the determination unit that no application program is suitable for the second identifier, no application program is associated with the second identifier.

3. The system according to claim 1, wherein
the second application program information includes identification information of the application program type; and
the determination unit can determine that a second application program that is different from the first application program is an application program suitable for the second identifier based on the identification information of the application program type.

4. The system according to claim 3, wherein the determination unit identifies same type application programs based on the identification information of the application program type and determines an application program suitable for the second identifier from among the identified same type application programs.

5. The system according to claim 1, wherein
the second application program information further includes identification information of target model; and
the determination unit identifies same type application programs based on the identification information of target model and determines, as an application program suitable for the second identifier, an application program including identification information on the second identifier as the target model identification information of target model from among the identified same type application programs.

6. The system according to claim 1, wherein the determination unit performs the determination based on information including at least one of a target model, target region, or target language of each application program.

7. The system according to claim 1, wherein the second application program information includes identification information of application program, identification information of application program type, and identification information of target model.

8. The system according to claim 1, wherein each application program is a Web application program.

9. The system according to claim 1, further comprising a management unit configured to manage a plurality of application programs, wherein
the obtaining unit obtains application program information from the management unit; and
the management unit manages information on an application program and the second identifier associated by the association unit.

10. An apparatus comprising:
a management unit configured to manage an application program associated with an information processing apparatus;
a transmitting unit configured to transmit a request for registering the information processing apparatus if an information processing apparatus managed by the management unit is added or is replaced; and
a receiving unit configured to receive information on an application program suitable for the information processing apparatus in response to the request for registering, wherein
the management unit manages application programs associated with the added or replaced information processing apparatus based on the information on the application program received by the receiving unit.

11. A method comprising:
obtaining first application program information associated with a first application program used with a first identifier;
determining an application program suitable for a second identifier based on the obtained first application program information and a second application program information associated with each of application programs; and
associating the determined application program with the second identifier.

12. A method comprising:
managing an application program associated with an information processing apparatus;
transmitting a request for registering the information processing apparatus if an information processing apparatus managed by the management unit is added or is replaced; and
receiving information on an application program suitable for the information processing apparatus in response to the request for registering, wherein
in the managing, application programs associated with the added or replaced information processing apparatus is managed based on the information on the application program received by the receiving unit.

13. A computer readable storage medium configured to store computer executable instructions for causing a computer to execute a method, the method comprising:
obtaining first application program information associated with a first application program used with a first identifier;
determining an application program suitable for a second identifier based on the obtained first application program information and a second application program information associated with each of application programs; and
associating the determined application program with the second identifier.
